(19) United States
(12) Patent Application Publication
(10) Pub. No.: US 2026/0229562 A1
(43) Pub. Date: Aug. 6, 2026

(54) METHOD OF DIAGNOSING AND PREVENTING DISCONNECTION OF FUEL CELL HUMIDIFIER

(71) Applicants: Hyundai Motor Company, Seoul (KR); Kia Corporation, Seoul (KR)

(72) Inventors: Young Pin JIN, Hwaseong-si (KR); Won Sub HAN, Hwaseong-si (KR); Jeong Woo PARK, Hwaseong-si (KR); Seong Ik JANG, Hwaseong-si (KR); Ju Young LEE, Hwaseong-si (KR); Seung Won BAIK, Hwaseong-si (KR)

(21) Appl. No.: 19/457,778

(22) Filed: Jan. 23, 2026

(30) Foreign Application Priority Data
Feb. 4, 2025 (KR) 10-2025-0013599

(51) Int. Cl. H01M 8/04664; H01M 8/04119; H01M 8/04225; H01M 8/04228; H01M 8/0438; H01M 8/04537; H01M 8/04746

(52) U.S. Cl. CPC H01M 8/04686; H01M 8/04126; H01M 8/04225; H01M 8/04228; H01M 8/0441; H01M 8/04559; H01M 8/04589; H01M 8/04753

(57) ABSTRACT

A method of diagnosing and preventing disconnection of a fuel cell humidifier includes calculating an accumulated amount of hydrogen peroxide per hour, determining whether the accumulated amount of hydrogen peroxide per hour is within a set range, entering a disconnection delay stage corresponding to the set range if the accumulated amount of hydrogen peroxide per hour is within the set range, calculating an accumulated amount of an air oversupply excess from the calculated accumulated amount of hydrogen peroxide per hour, and determining whether the accumulated amount of the air oversupply excess exceeds a set value.

### CROSS-REFERENCE TO RELATED APPLICATION

This application claims under 35 U.S.C. § 119(a) the benefit of priority from Korean Patent Application No. 10-2025-0013599 filed on Feb. 4, 2025, the entire contents of which are incorporated herein by reference.

### TECHNICAL FIELD

The present disclosure relates to diagnostic and control technology for ensuring durability of a fuel cell system. More particularly, it relates to technology for preventing disconnection that may occur in a humidifier tube to improve stack durability, and continuously maintain stability and efficiency of a fuel cell system.

### BACKGROUND

In order to ensure stack durability in a fuel cell system, technology for preventing and continuously monitoring humidifier tube separator breakage has been developed. The purpose of this technology is to control an internal environment that occurs depending on stack operating conditions to maintain stability and efficiency of the fuel cell system.

A humidifier may be used to prevent drying of a fuel cell stack and increase overall power efficiency of the fuel cell stack and/or a fuel cell system comprising the fuel cell stack. Humidity control contributes to stack durability and serves to maintain the performance of the fuel cell system at least at a certain level. Humidity control may maintain moisture balance within the stack to support efficient energy conversion.

However, damage to a humidifier tube of the humidifier may accumulate (e.g., during long-term operation). Such damage may lead to a risk of disconnection of the humidifier tube from the fuel cell stack. Such a disconnection problem may break/disrupt moisture balance in the fuel cell stack and/or, in the long term, deteriorate durability of the fuel cell stack, threatening stability of the system. Disconnection of the humidifier tube may not be detected (e.g., in real time) and/or prevented, which may thus lead to unexpected system damage.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses/devices, and methods are described for diagnosing and preventing disconnection of a fuel cell humidifier. A humidifier system may comprise: a fuel cell stack; a humidifier configured to control humidity in the fuel cell stack; a sensor system comprising a plurality of sensors configured to measure operating status information of the fuel cell stack; and a controller circuit. The controller circuit may be configured to: determine, based on the operating status information received from the sensor system, an accumulated amount of hydrogen peroxide produced by the fuel cell stack; and control operation of the fuel cell stack according to a fuel cell stop threshold and a fuel cell restart threshold, wherein the fuel cell stop threshold and the fuel cell restart threshold are based on whether an accumulation rate of hydrogen peroxide is within a set range.

A method may be performed by an apparatus of a humidifier system. The method may comprise: receiving, by a controller circuit and from a sensor system, operating status information of a fuel cell stack; determining, by the controller circuit based on the operating status information, an accumulation rate of hydrogen peroxide produced by the fuel cell stack; determining, by the controller circuit, whether the accumulation rate of hydrogen peroxide is within one or more set ranges; controlling an operation of the fuel cell stack according to a fuel cell stop threshold and a fuel cell restart threshold, wherein the fuel cell stop threshold and the fuel cell restart threshold are controlled based on whether the accumulation rate of hydrogen peroxide is within the set range.

The method may also, or alternatively, comprise: determining, by a controller circuit, an accumulation rate of hydrogen peroxide produced by a fuel cell stack; controlling, by the controller circuit and based on the accumulation rate of hydrogen peroxide being within a set range, operation of the fuel cell stack according to one or more operation parameters corresponding to the set range; determining, by the controller circuit, an accumulated amount of an air oversupply excess from the accumulation rate of hydrogen peroxide; and causing, by the controller circuit and based on the accumulated amount of the air oversupply excess exceeding a set value, a user interface to output a notification indicating a risk of humidifier disconnection.

These and other features and advantages are described in greater detail below.

### BRIEF DESCRIPTION OF THE DRAWINGS

The above and other features of the present disclosure will now be described in detail with reference to certain examples thereof illustrated the accompanying drawings which are given hereinbelow by way of illustration only, and thus are not limitative of the present disclosure, and wherein:

FIG. 1 is a block diagram illustrating the configuration of a fuel cell system according to one example of the present disclosure;

FIG. 2 is a schematic flowchart illustrating a method of diagnosing and preventing disconnection of a fuel cell humidifier according to one example of the present disclosure;

FIG. 3A is a flowchart illustrating calculating an accumulated amount of hydrogen peroxide according to one example of the present disclosure;

FIG. 3B is a flowchart illustrating calculating an accumulated amount of hydrogen peroxide according to another example of the present disclosure; and

FIG. 4 is a specific flowchart illustrating the method of diagnosing and preventing disconnection of the fuel cell humidifier according to one example of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various examples of the present disclosure, examples of which are illustrated in the accompanying drawings and described below. The present disclosure is not limited to the following examples, and the examples may be implemented in various different forms with various substitutions and/or modifications without deviating from the scope of the disclosure. The examples are provided to make the description of the present disclosure thorough and to fully convey the scope of the present disclosure to those skilled in the art.

In the following description of the examples, it will be understood that the terms “unit” indicate units for processing at least one function or operation, and may be implemented as software, hardware, or a combination of software and hardware. Throughout the present disclosure, references to units generally refer to items that logically can be grouped together to perform a function or group of related functions. Like reference numerals are generally intended to refer to the same or similar units. The units and/or functions described herein may be implemented and/or performed by one or more processors. For examples, the units may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The units may also include software control module(s) implemented with a processor or logic circuitry for example. The units may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Unless otherwise defined, the terms used herein, including technical or scientific terms, may have meanings generally understood by those skilled in the art to which the present disclosure belongs.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

The terminology used herein is for the purpose of describing particular examples only and is not intended to be limiting. As used herein, singular expressions may be intended to include plural expressions as well, unless the context clearly indicates otherwise.

In the following description of the present disclosure, the terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some examples, “about” in connection with a number or range measured by a particular method indicates that the given numerical value includes values determined by the variability of that method.

In order to solve problems associated with humidifier tube disconnection, a method of detecting and preventing disconnection of a humidifier tube is provided. The present disclosure provides diagnostic and control technology that improves stack durability of a fuel cell system by diagnosing a risk of disconnection of a humidifier tube (e.g., in real time) and performing a control mode to delay and/or prevent occurrence of the disconnection.

For example, a controller herein (such as controller 40) may include a communication device (e.g., a control device, a control circuit, etc.) communicating with other controllers and/or one or more sensors to control one or more functions and/or operations in charge, a memory storing an operation system, a logic command, and input/output information, and/or one or more processors performing determination, calculation, and decision necessary for controlling the function in charge. The controllers herein may be implemented as a memory that stores data on an algorithm for controlling operation of various components disposed in a vehicle or a program that reproduces the algorithm, and a processor that performs the above-described operation using the data stored in the memory. The memory and the processor may be implemented as separate chips and/or the memory and the processor may be implemented as a single chip. For example, the controller 40 may include at least two of an electronic control unit (ECU), a central processing unit (CPU), a microprocessor unit (MPU), a microcontroller unit (MCU), an application processor, or any other type of processor well known in the technical field of the present disclosure.

Also, or alternatively, the controller 40 may be configured as a combination of software and hardware capable of performing operations for at least two applications or programs for executing a method according to examples of the present disclosure.

Hereinafter, the examples will be described in detail with reference to the accompanying drawings, and in the following description with reference to the accompanying drawings, the same reference numbers will be given to the same or corresponding components, and a redundant description thereof will be omitted.

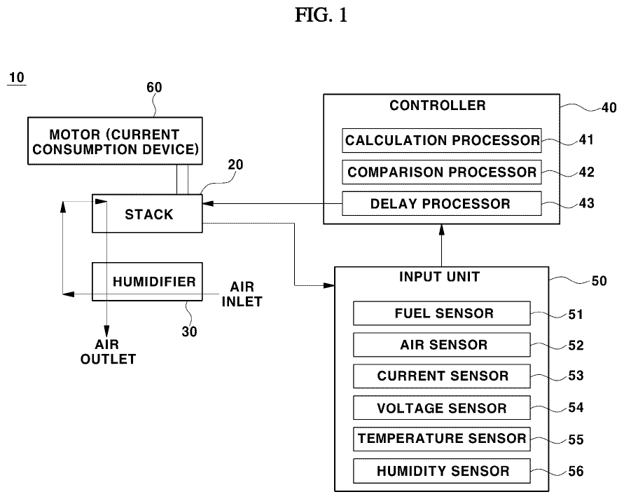

FIG. 1 is a block diagram illustrating the configuration of a fuel cell system 10 according to one example of the present disclosure.

According to an example of the present disclosure, the fuel cell system 10 includes a fuel cell stack 20, a humidifier 30, the controller 40, and an input unit 50 (e.g., a sensor system, a fuel cell monitoring system).

The stack 20 (e.g., fuel cell stack comprising a plurality of fuel cells) of the fuel cell system 10 may produce electricity via an oxidation-reduction (REDOX) reaction between fuel (hydrogen) and air. The electricity produced by the stack 20 may be transmitted to a motor 60 and/or used as a power source for a vehicle and/or other driving operations and/or supplied to the outside.

The humidifier 30 may be configured to humidify air supplied to the stack 20 to control the internal humidity of the stack 20. For example, the humidifier may be located at the front end of the stack 20 to humidify the supplied air. The humidifier 30 may mix fine particles of water with the air supplied to the stack 20 to control the internal humidity of the stack 20.

The controller 40 (e.g., controller circuit) may comprise one or more units and/or processors, referred to herein as a calculation processor 41, comparison processor 42, and delay processor 43. The calculation processor 41, comparison processor 42 and delay processor 43 may each comprise one or more processors and/or one or more of the calculation processor 41, comparison processor 42 and delay processor 43 may be implemented by a single processor (e.g., a single processor may implement the calculation processor 41, comparison processor 42 and delay processor 43). The calculation processor 41, comparison processor 42 and delay processor 43 may be in communication with each other (e.g., transmit and received information from each other), either by inter-processor wired and/or wireless communications (e.g., in a case where they are implemented as separate processors) or by intra-processor wired and/or wireless communications (e.g., in a case where the communicating elements are implemented by a single processor).

The input unit 50 (e.g., sensor system and/or sensor control device/circuit, fuel cell monitoring system) may collect data from one or more sensors (e.g., sensors 51-56). the one or more sensors may be part of the input unit 50 and/or in communication with the input unit 50). The one or more sensors may be mounted inside and/or outside the stack 20. The one or more sensors may be configured to measure/detect and/or provides information, such as a fuel amount, an air amount, a current, a voltage, etc., of the stack 20 and/or one or more fuel cells of the stack, to the controller 40 (e.g., to a calculation processor 41 of the controller 40). The sensors may include, for example, a fuel sensor 51, an air sensor 52, current sensors 53, voltage sensors 54, a temperature sensor 55, and a humidity sensor 56.

The fuel sensor 51 may be configured to measure the flow of hydrogen (e.g., fuel) entering the stack 20 (e.g., in real time). For example, the fuel sensor 51 may be located at the inlet of the stack 20. The air sensor 52 may measure/detect (e.g., in real time) the amount of air supplied to the stack 20. For example, the air sensor may be located at the inlet of the stack 20 and measure air (and/or oxygen) entering the stack 20 in the same manner as the fuel sensor 51.

The current sensors 53 may be configured to detect current generated the stack 20 (e.g., in each cell in the stack 20). For example, the current sensors 53 may be located inside and at the outlet of the stack 20 and detect/measure current generated by the fuel cell. The voltage sensors 54 may be configured to detect/measure a voltage of each cell and/or of the entire stack 20. For example, the voltage sensors 54 may be located inside and at the outlet of the stack 20.

The temperature sensor 55 (e.g., disposed in the stack 20) may be configured to detect a change in an internal temperature of the stack 20 and provide temperature information to the controller 40. The humidity sensor 56 (e.g., located in the stack 20) may be configured to check/measure a humidity state (e.g., level/amount of humidity) in the stack 20 (e.g., in real time) and transmit humidity information to the controller 40.

The input unit 50 may collect information (e.g., fuel amount, air amount, current, and voltage) from these sensors, and transmit the information to controller 40 (e.g., to the calculation processor 41).

The calculation processor 41 may determine/calculate the accumulated amount of hydrogen peroxide based on the fuel amount (hydrogen amount), air amount, current, and voltage information transmitted from the input unit 50.

As an example of the present disclosure, the calculation processor 41 may determine/calculate the accumulated amount of hydrogen peroxide by calculating a stoichiometric ratio (SR) based on the fuel amount and air amount information transmitted from the input unit 50. Here, the stoichiometric ratio refers to the ratio of fuel (hydrogen) to air supplied to the stack 20 in the fuel cell system 10 and is defined by the formula “Stoichiometric ratio (SR)=supplied air amount÷required air amount”.

The stoichiometric ratio may be adjusted based on current generated by fuel cells of the stack 20. For example, an increase in current indicates an increase in an electrochemical reaction rate, so the supplied air amount may be adjusted in proportion to a required oxygen consumption. The stoichiometric ratio is related to an oxidation reaction in the fuel cells as well as production of hydrogen peroxide. If oxygen is supplied in excess and hydrogen is insufficient, hydrogen peroxide (H₂O₂) is produced through an incomplete oxygen reduction reaction (O₂+2H++2e−→H₂O₂). That is, in the state in which oxygen is supplied in excess, oxygen (O₂) accepts hydrogen ions (H+) and electrons (e−), is not completely reduced, and thus forms hydrogen peroxide (H₂O₂).

Therefore, the calculation processor 41 may proportionally determine/calculate the amount of hydrogen peroxide produced using the stoichiometric ratio. For example, depending on how much the stoichiometric ratio exceeds a reference value (e.g., 1), the calculation processor 41 may determine/calculate an expected amount of hydrogen peroxide produced by applying a proportional coefficient. In some examples, the calculation processor 41 may calculate the amount of hydrogen peroxide produced using the formula “Amount of hydrogen peroxide produced=(Stoichiometric ratio−1)×Proportional coefficient”.

For example, if the Stoichiometric ratio is 1.2, the amount of hydrogen peroxide produced may be calculated as (1.2-1)×proportional coefficient. The proportional coefficient may be determined based on system design and/or test data. The proportional coefficient may be set so that, as the degree to which the stoichiometric ratio exceeds 1 increases, the amount of hydrogen peroxide produced increases proportionally.

As another example, the calculation processor 41 may predict/determine/estimate the amount of hydrogen peroxide produced using current and voltage characteristics. By comparing the initial output state (e.g., voltage and/or current output) and the current output state (e.g., voltage and/or current output) of the fuel cell system 10, the amount of hydrogen peroxide may be estimated based on how much the current output has decreased. In some examples, the calculation processor 41 may calculate the amount of hydrogen peroxide produced using the formula “Amount of hydrogen peroxide produced=Output reduction ratio×Proportional coefficient”.

The calculation processor 41 may determine/calculate the amount of hydrogen peroxide produced, and/or determine/calculate the accumulated amount of hydrogen peroxide over time (e.g., per hour) based on the calculated amount of hydrogen peroxide produced.

A comparison processor 42 may perform comparison between data determined/calculated by the calculation processor 41 and a set value stored in the controller 40 (e.g., one or more threshold values and/or set ranges). The comparison processor 42 may compare the accumulated amount of hydrogen peroxide per hour (e.g., calculated by the calculation processor 42) with the set value stored in the controller 40 and transmit a comparison signal to a delay processor 43.

The delay processor 43 may, based on the comparison signal transmitted from the comparison processor 42, adjust (e.g., strengthen) a stop threshold of the fuel cell stack 20 and/or a restart threshold of the fuel cell stack 20 and/or limit the output increase rate of the fuel cell stack 20. Thereby, the delay processor 43 may prevent tube separator breakage of the humidifier 30 caused by frequent fuel supply stop and/or rapid acceleration.

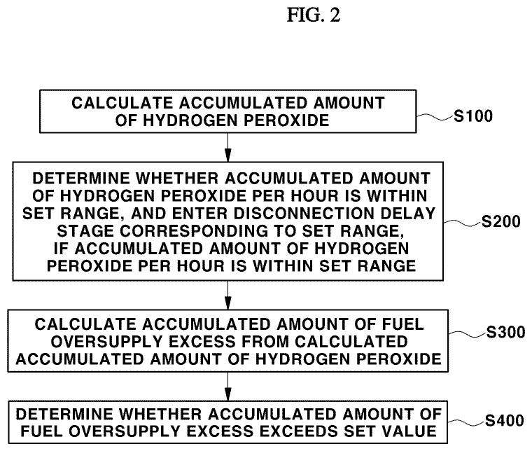

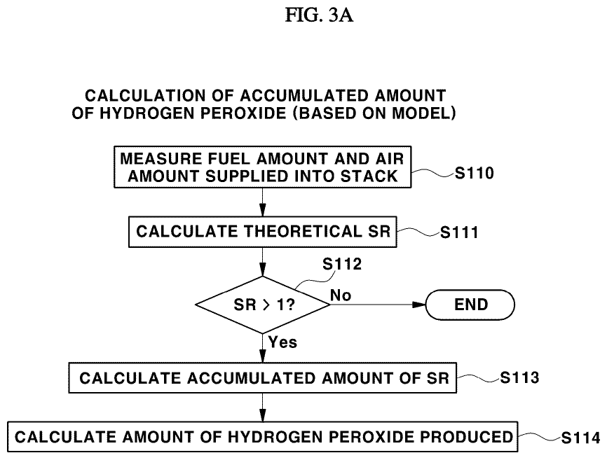

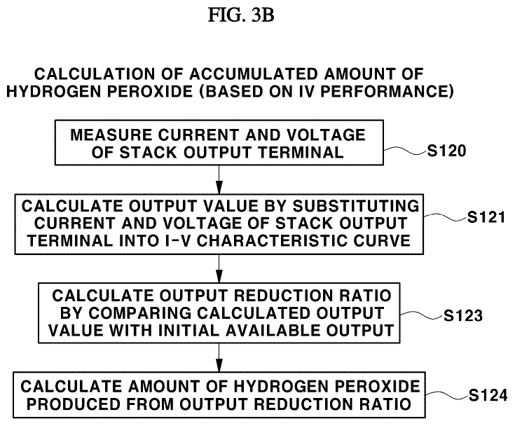

FIG. 2 is a schematic flowchart illustrating a method of diagnosing and preventing disconnection in the stack 20 and the humidifier 30, and FIGS. 3A and 3B are flowcharts illustrating calculating the accumulated amount of hydrogen peroxide. For convenience, FIGS. 2 and 3A-3B are described by way of an example in which the steps are performed by a processor circuit (e.g., controller circuit of controller 40). One, some, or all steps of the example methods of FIG. 2 and 3A-3B, or portions thereof, may be performed by one or more other circuits. One or some, steps of the example method of FIGS. 2 and 3A-3B may be omitted, performed in other orders, and/or otherwise modified, and/or one or more additional steps may be added.

The method may include determining/calculating (e.g., by the calculation processor 41) the accumulated amount of hydrogen peroxide produced (S100).

The calculation processor 41 may determine/calculate the accumulated amount of hydrogen peroxide produced using the stoichiometric ratio, the output current and output voltage of the stack 20, and the temperature and humidity of the stack 20.

For example, the input unit 50 (e.g., one or more sensors of/associated with the input unit 50) may measure a fuel amount and an air amount supplied into the stack 20 (S110). The input unit 50 may transmit information on/indicating the measured fuel amount and air amount to the controller 40 (e.g., to the calculation processor 41). The stoichiometric ratio may be calculated/determined (e.g., by the calculation processor 41) based on the received fuel amount and air amount (S111).

The accumulated amount of hydrogen peroxide may be determined/calculated (e.g., by the calculation processor 41) from the stoichiometric ratio. For example, the calculation processor 41 may determine/calculate the stoichiometric ratio and transmit information on/indicating the stoichiometric ratio to the comparison processor 42.

The stoichiometric ratio (e.g., calculated by the calculation processor 41) may be compared (e.g., by the comparison processor 42) with the reference value (e.g., 1) to determine whether the stoichiometric ratio exceeds the reference value (S112). If the stoichiometric ratio does not satisfy and/or exceed the reference value (S112—No), the process may end and/or return to measuring/monitoring the fuel amount and air amount (S110). If the stoichiometric ratio is determined to exceed the reference value (S112—Yes), an accumulated amount of the stoichiometric ratio may be determined (S113). In determining whether the stoichiometric ratio exceeds the reference value of 1, the comparison processor 42 may determine whether the stoichiometric ratio exceeds the reference value, and also quantitatively evaluate a possibility of producing hydrogen peroxide based on a degree to which the stoichiometric ratio exceeds the reference value.

A degree of risk of producing hydrogen peroxide may be evaluated/determined (e.g., by the controller 40 and/or comparison processor 42) based on the degree to which the stoichiometric ratio meets or exceeds the reference value. For example, a stoichiometric ratio exceeding 1.0 but less than 1.1 may be defined as “minor excess”, a stoichiometric ratio of 1.1 or more but less than 1.3 may be defined as “moderate excess”, and a stoichiometric ratio of 1.3 or more “high risk excess”. Theses specific cut-off values and defined ranges may vary (e.g., more or fewer ranges may be selected and the range boundary values

The comparison processor 42 may set the degree of risk of producing hydrogen peroxide in stages based on each excess range, and reflect the set degree of risk of producing hydrogen peroxide in signal strength to be transmitted to the calculation processor 41 (e.g., signal strength proportional to the set degree of risk). The accumulated amount of the stoichiometric ratio may be determined/calculated (e.g., by the calculation processor 41 based on the received signal strength) based on the degree to which the stoichiometric ratio exceeds the reference value (S113). The calculation processor 41 may quantitively calculate the amount of hydrogen peroxide produced from the determined/calculated accumulated amount of the stoichiometric ratio.

The comparison processor 42 may monitor the duration of a state in which the stoichiometric ratio exceeds the reference value, and transmits information on/indicating the duration to the calculation processor 41 for use in determining/calculating the accumulated amount of hydrogen peroxide produced (e.g., depending on the duration of the state in which the stoichiometric ratio exceeds the reference value). For example, if the state in which the stoichiometric ratio exceeds 1 continues for 300 seconds or longer, the comparison processor 42 may transmit information to the calculation processor 41 indicating the duration, such that the expected accumulated amount of hydrogen peroxide produced for the duration may be calculated. The calculation processor 41 may calculate the accumulated amount of hydrogen peroxide produced, which increases as the state in which the stoichiometric ratio exceeds 1 continues, based on the duration of the state in which the stoichiometric ratio exceeds 1, and apply a model in which the increase of the accumulated amount of hydrogen peroxide produced over time is reflected.

The multiple thresholds may be set based on/relative to the reference value of 1. A signal may be transmitted (if the stoichiometric ratio exceeds a/each threshold) to the calculation processor 41 to calculate an expected amount of hydrogen peroxide produced in stages. For example, if the stoichiometric ratio exceeds any of the thresholds (e.g., 1.1, 1.2, 1.3, or the like) the calculation processor 41 may determine/calculate the amount of hydrogen peroxide produced at the exceeding level. The calculation processor 41 may predict/determine that the amount of hydrogen peroxide produced increases as the stoichiometric ratio exceeds a higher threshold. The expected amount of hydrogen peroxide produced may be determined/calculated depending on the threshold (S114).

As another example of the present disclosure, the calculation processor 41 may calculate the amount of hydrogen peroxide produced based on measured current and/or voltage of a stack output terminal.

The input unit 50 may measure the current and/or voltage of the stack output terminal (S120). The input unit 50 may transmit the measured current and/or voltage of the stack output terminal to the calculation processor 41.

The calculation processor 41 may receive values of the current and voltage of the stack output terminal from the input unit 50 and calculate a current output value by substituting the received current and/or voltage values into the current-voltage characteristic curve of the fuel cell system 10 (S121). Furthermore, the calculation processor 41 may determine/calculate an output reduction ratio by comparing the currently calculated output value with an initial available output value.

For example, if a theoretical output value in the initial state is 40 W, the output reduction ratio may be calculated as “Output reduction ratio=(Initial available output−Current output)/Initial available output=(40 W-35 W)/40 W=0.125 (12.5%)”.

The output reduction ratio means that the output of the fuel cell stack 20 has decreased by 12.5% compared to the initial available output, and the calculation processor 41 uses the output reduction ratio as a key index of a possibility of producing hydrogen peroxide (S123).

The calculation processor 41 may determine/calculate the expected amount of hydrogen peroxide produced based on the calculated output reduction ratio. For example, if a proportional coefficient is 0.05, the calculation processor 41 may calculate the expected amount of hydrogen peroxide produced as “Amount of hydrogen peroxide produced=0.125×0.05=0.00625” using the formula “Amount of hydrogen peroxide produced=Output reduction ratio×Proportional coefficient”.

For example, the calculation processor 41 may determine/calculate the amount of hydrogen peroxide as 0.00625 mg/h using the output reduction ratio and the proportional coefficient. This may indicate that, as the output reduction ratio increases, the amount of hydrogen peroxide produced also increases proportionally.

The accumulated amount of hydrogen peroxide may be determined/calculated (e.g., by the calculation processor 41). Data on/indicating the accumulated amount of hydrogen peroxide per hour may be calculated/determined based on the accumulated amount of hydrogen. The data on/indicating the accumulated amount of hydrogen peroxide per hour may be transmitted (e.g., by the calculation processor 41) to the comparison processor 42.

The comparison processor 42 may determine whether the received accumulated amount of hydrogen peroxide per hour is within a set range. For example, the comparison processor 42 may determine whether the accumulated amount of hydrogen peroxide per hour is greater than or equal to a first set value and less than a second set value, or whether the accumulated amount of hydrogen peroxide per hour is greater than or equal to the second set value. If the accumulated amount of hydrogen peroxide per hour is within the set range, the comparison processor 42 may initiate a disconnection delay stage corresponding to the set range (S200).

The first set value may be a reference value that reflects the operating status of the fuel cell system 10 under normal driving conditions of the vehicle in which the tube separator of the humidifier 30 is disconnected. The first set value may be used as an index to evaluate the increase rate of the accumulated amount of hydrogen peroxide per hour. The first set value may indicate a rate at which the accumulated amount of hydrogen peroxide increases for a specific time and may be used as a reference to monitor the hydrogen peroxide production tendency of the fuel cell system 10 and apply a control stage.

The first set value may be determined based on a frequency of stops of the fuel cell stack 20 and a stoichiometric ratio (SR) excess. For example, the first set value may be set based on an average (e.g., the median) statistical data reflecting the normal driving conditions of the vehicle in which the tube separator of the humidifier 30 is disconnected. The first set value may also, or alternatively, be set based on a condition in which it takes about 8,000 hours for the accumulated amount of the stoichiometric ratio (SR) excess to reach 40,000. For example, the frequency of stops of the fuel cell stack 20 may be set to 2.5 times/km. This value be converted to 100 times per hour based on an average speed of 20 km/h.

The first set value may be set to reflect the frequency of stops of the fuel cell stack 20 determined based on time and the frequency of maintenances of the fuel cell stack 20 depending on a distance, under the normal driving conditions of the vehicle in the state in which the tube separator of the humidifier 30 is disconnected.

The second set value may be a reference value that reflects a situation in which harsh driving conditions of the vehicle in the state in which the tube separator of the humidifier 30 is disconnected. The second set value may be used as an index for evaluating the increase rate of the accumulated amount of hydrogen peroxide per hour.

The second set value may indicate a rate at which the accumulated amount of hydrogen peroxide increases for/over a specific time under the harsh driving conditions, for example. The second set value may be used as an index to determine the control stage.

Harsh driving conditions herein may mean conditions in which the frequency of stops of the fuel cell stack 20 per hour and/or per distance is high (e.g., relative to “normal driving conditions). The increase rate of the accumulated amount of a fuel oversupply excess may therefore be high compared to the normal driving conditions.

Under the normal driving conditions, the fuel cell stack 20 may stop at about 2.5 times/km during driving. The accumulated amount of the fuel oversupply excess may accordingly increase at about the stoichiometric ratio of 10 per hour. Under the harsh driving conditions, the fuel cell stack 20 may stop at about 5 times/hr (e.g., at about 5 times/km during driving). The accumulated amount of the fuel oversupply excess may increase twice as fast as about the stoichiometric ratio of 10 per hour.

Therefore, under the harsh driving conditions, the load on the fuel cell stack 20 and the tube of the humidifier 30 may increase, and the accumulated amount of hydrogen peroxide increases accordingly (e.g., more rapidly than under the normal driving conditions).

The numerical values discussed herein serve as example values for references under such specific conditions. Other numerical values may serve as the references under different specific conditions, and the discussed values may vary depending on a control environment and specifications. That is, the numerical values that serve as the references for determining the normal driving conditions or the harsh driving conditions are not limited to numerical values given in the following description.

The second set value may be calculated based on a top percentage (e.g., top 1%) statistical data reflecting the frequency of stops of fuel cell stack 20 and a stoichiometric ratio excess under the harsh driving conditions of the vehicle in which the tube separator of humidifier 30 is disconnected. for example, the second set value may be set to reflect a condition in which it takes about 4,000 hours for the accumulated amount of the stoichiometric ratio (SR) excess to reach 40,000. For example, under the harsh driving conditions of the vehicle in which the tube separator of the humidifier 30 is disconnected, the frequency of stops of the fuel cell stack 20 may be set to 5 times/km. This value may be converted to 100 times per hour based on an average speed of 20 km/h. The stoichiometric ratio excess may be applied as 0.1 per stop of the fuel cell stack 20. The stoichiometric ratio excess may be set to the stoichiometric ratio of 10 per hour.

The second set value may be set by reflecting the frequency of stops of the fuel cell stack 20 depending on time and the frequency of maintenances of the fuel cell stack 20 depending on distance under the harsh driving conditions of the vehicle in the state in which the tube separator of the humidifier 30 is disconnected.

A slope of the accumulated amount of hydrogen peroxide of the second set value may be greater than a slope of the accumulated amount of hydrogen peroxide of the first set value. If the slope of the accumulated amount of hydrogen peroxide in the stack 20 and the humidifier 30 is greater than or equal to the second set value, a risk of disconnection of the tube separator of the humidifier 30 may be high.

Because the first set value is based on the normal driving conditions of the vehicle in which the tube separator of the humidifier 30 is disconnected and the second set value is based on the harsh driving conditions of the vehicle in which the tube separator of the humidifier 30 is disconnected, the accumulated amount of hydrogen peroxide per hour of the first set value may be smaller than the accumulated amount of hydrogen peroxide per hour of the second set value.

A determination may be made (e.g., by the comparison processor 42) as to whether the accumulated amount of hydrogen peroxide per hour is greater than or equal to the first set value but is less than the second set value, or whether the accumulated amount of hydrogen peroxide per hour exceeds the second set value. If the accumulated amount of hydrogen peroxide per hour is greater than or equal to the first set value but is less than the second set value, a signal corresponding to the accumulated amount of hydrogen peroxide per hour (e.g., which may be greater than or equal to the first set value but is less than the second set value) may be applied/sent (e.g., by the comparison processor 42 to the delay processor 43). If the accumulated amount of hydrogen peroxide per hour is greater than or equal to the second set value, a signal corresponding to the accumulated amount of hydrogen peroxide per hour (e.g., which may be greater than or equal to the second set value) may be applied/sent (e.g., by the comparison processor 42 to the delay processor 43).

The signal corresponding to the accumulated amount of hydrogen peroxide per hour that is greater than or equal to the first set value but is less than the second set value may be received by the controller 40 (e.g., the delay processor 43) and may initiate/cause entry to a first step of the humidifier tube separator breakage delay stage. The signal corresponding to the accumulated amount of hydrogen peroxide per hour that is greater than or equal to the second set value may be received (e.g., by the controller 40 and/or the delay processor 43), and may initiate/cause entry to a second step of the humidifier tube separator breakage delay stage.

Initiating/entering the disconnection delay stage (e.g., by the delay processor 43) may comprise strengthening (e.g., increasing a strictness of) a stop threshold and/or a restart threshold of the fuel cell stack 20. Strengthening the thresholds my reduce stopping/restarting the fuel cell stack, which may reduce/delay production of hydrogen peroxide due to frequent stop of the fuel cell stack 20. Initiating/entering the disconnection delay stage may also, or alternatively, limit/reduce the output increase rate of the fuel cell stack 20 (e.g., to delay production of hydrogen peroxide). The delay processor 32 may delay production of hydrogen peroxide to delay the disconnection of the tube separator of the humidifier 30. For example, the stack restart threshold of a fuel cell shutdown system may refer to the restart threshold of the fuel cell stack 20 after stopping of the fuel cell stack 20.

The controller 40 (e.g., delay processor 43) may delay/reduce production of hydrogen peroxide by strengthening the stop threshold of the fuel cell stack 20.

For example, before entering the disconnection delay stage, the fuel cell shutdown system is operated to stop the fuel cell system 10 when the output of the fuel cell stack 20 is lowered to 20 kW or less, and on the other hand, after entering the disconnection delay stage, the delay processor 43 strengthens demand output may be strengthened (e.g., increased; e.g., by the controller 40 and/or delay processor 43) to stop/limit the fuel cell stack 20 to a certain power output (e.g., to about 10 kW) or less, so that the fuel cell shutdown system is operated at a lower output state than a default setting value (e.g., stored in the controller 40). This may cause the fuel cell system 10 to stop only if the output is sharply lowered (e.g., to a certain level or less), thereby preventing the fuel cell system 10 from being unnecessarily stopped, thereby reducing/delaying production of hydrogen peroxide.

The delay processor 43 may reduce/delay production of hydrogen peroxide by strengthening the restart threshold of the fuel cell stack 20 (e.g., restarting after stopping the fuel cell stack 20).

For example, when not in the disconnection delay stage (e.g., before initiating/entering the disconnection delay stage), the fuel cell system 10 may be stopped (e.g., the stack 20 may not be outputting power and/or be outputting limited power) and then allowed to be restarted when/if the output is recovered to 10 kW or more. Also, or alternatively, after/based on initiation of/entering the disconnection delay stage, the delay processor 43 may strengthen the demand output to restart the fuel cell stack 20 to 15 kW or more, so that the fuel cell stack 20 is restarted only at a higher output state.

That is, the delay processor 43 may suppress production of hydrogen peroxide by reducing the frequency of stops of the fuel cell stack 20 by strengthening the stop threshold of the fuel cell stack 20 and/or the restart threshold of the fuel cell stack 20, thereby reducing/delaying the disconnection of the tube separator of the humidifier 30. The controller 40 (e.g., the delay processor 43) may suppress production of hydrogen peroxide by reducing/limiting the output increase rate of the fuel cell stack 20 (e.g., in a rapid acceleration situation). For example, the output increase rate may be controlled to (e.g., gradually) increase output of the stack 20 to a certain level or less (e.g., to at most the certain level) if rapid acceleration is detected, thereby preventing the output of the fuel cell stack 20 from rapidly increasing. For example, when/of no in the disconnection delay stage (e.g., before initiating/entering the disconnection delay stage), the output of the fuel cell stack 20 may rapidly increase from 10 kW to 20 kW in a short period of time. After initiating/entering the disconnection delay stage, the delay processor 43 may limit/reduce the output increase rate in stages so that the output increase rate gradually increases by 5 kW/h. This may avoid exposing the fuel cell system 10 not to a sudden load, even during rapid acceleration, thereby reducing/delaying production of hydrogen peroxide.

After the delay processor 43 performs the disconnection delay stage, the calculation processor 41 may (e.g., continuously/repeatedly) calculate the accumulated amount of an air oversupply excess from the accumulated amount of hydrogen peroxide produced.

The accumulated amount of the air oversupply excess may be an index that quantitatively indicates the accumulated amount of a fuel oversupply excess (e.g., a fuel supply supplied excessively compared to an air supply, where excess is determined based on the amount of hydrogen peroxide produced). The accumulated amount of the air oversupply excess may be indirectly calculated from the amount of hydrogen peroxide produced if/when the stoichiometric ratio exceeds the reference value of 1 in the fuel cell system.

For example, in order to determine/calculate the accumulated amount of the air oversupply excess from the accumulated amount of hydrogen peroxide, the calculation processor 41 may set a proportional coefficient based on data and/or a formula that represents the correlation between the amount of hydrogen peroxide produced and the fuel oversupply excess. The proportional coefficient may indicate the correlation that the fuel oversupply excess increases at a certain rate when the amount of hydrogen peroxide increases.

The calculation processor 41 may determine/calculate the fuel oversupply excess at a corresponding point in time by multiplying the accumulated amount of hydrogen peroxide measured in real time by the proportional coefficient. For example, the fuel oversupply excess may be determined/calculated as a value obtained by multiplying the accumulated amount of hydrogen peroxide by the proportional coefficient. In this way, the calculation processor 41 may determine/estimate the corresponding oversupply excess based on the accumulated amount of hydrogen peroxide exceeding a certain reference.

The calculation processor 41 may (e.g., continuously/repeatedly) determine/calculate the accumulated amount of the fuel oversupply excess by accumulating the fuel oversupply excess calculated for a specific time. An extent to which the fuel oversupply state continuously occurs may be quantitatively calculated (S300).

The calculation processor 41 may transmit information on/indicating the calculated fuel oversupply excess to the comparison processor 42.

The comparison processor 42 may receive the information on the accumulated amount of the fuel oversupply excess. A determination may be made (e.g., by the comparison processor 42) as to whether the accumulated amount of the fuel oversupply excess exceeds a third set value (S400).

The third set value may refer to a point in time when/at which the accumulated amount of fuel oversupply excess reaches 40,000 (e.g., reflecting the harsh driving conditions of the vehicle in which the tube separator of the humidifier 30 is disconnected). The third set value may be set based on the top 1% statistical data obtained based on driving data of the vehicle in which the tube separator of the humidifier 30 is disconnected.

The frequency of stops of the fuel cell stack 20 and the stoichiometric ratio excess may be reflected in the third set value. Under the harsh driving conditions of the vehicle in which the tube separator of the humidifier 30 is disconnected, the frequency of stops of the fuel cell stack 20 may be, for example, about 5 times/km or more. This value may be determined/calculated as 100 times per hour based on an average speed of 20 km/h.

The accumulated amount of the fuel oversupply excess may be calculated by (e.g., continuously and/or periodically) accumulating an excess amount if the stoichiometric ratio exceeds 1. For example, if the stoichiometric ratio is 1.2, the excess amount of 0.2. is added to the accumulated amount of the fuel oversupply excess. In this way, if the accumulated amount of the fuel oversupply excess of the driving vehicle is calculated and exceeds 40,000, the comparison processor 42 may determine that the accumulated amount of the fuel oversupply excess exceeds the third set value.

If the accumulated amount of the fuel oversupply excess exceeds the third set value, the controller 40 and/or comparison processor 42 may determine that the tube separator of the humidifier 30 is on the verge of disconnection, and may generate/cause output of a notification regarding a factory repair request (e.g., output to a user interface, such as a speaker and/or screen of the vehicle, and/or a user device, such as a mobile phone, etc.). For example, the notification may indicate a warning and/or risk of humidifier tube disconnection.

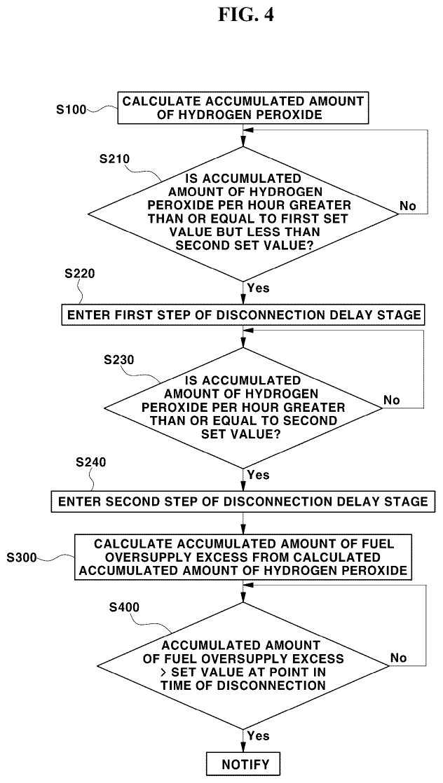

FIG. 4 is a flowchart illustrating the method of diagnosing and preventing disconnection in the stack 20 and the humidifier 30, according to an example of the present disclosure. For convenience, FIG. 4 is described by way of an example in which the steps are performed by a processor circuit (e.g., the controller 40/controller circuit). One, some, or all steps of the example method of FIG. 4, or portions thereof, may be performed by one or more other circuits. One or some, steps of the example method of FIG. 4 may be omitted, performed in other orders, and/or otherwise modified, and/or one or more additional steps may be added.

The accumulated amount of hydrogen peroxide produced may be determined/calculated (S100).

The accumulated amount of hydrogen peroxide produced may be calculated (e.g., by the controller 40 and/or calculation processor 41) based on data collected from the input unit 50. For example, the calculation processor 41 may calculate the amount of hydrogen peroxide produced using the input stoichiometric ratio and the output reduction ratio and may calculate the accumulated amount of hydrogen peroxide by accumulating the amount of hydrogen peroxide produced.

Also, or alternatively, the accumulated amount of hydrogen peroxide may be determined/calculated (e.g., by the controller 40 and/or calculation processor 41) using a change in the internal temperature of the stack 20. For example, the calculation processor 41 may employ a temperature correction coefficient that reflects a characteristic in which the hydrogen peroxide production reaction is promoted as the temperature increases.

The predefined temperature coefficient may be determined/calculated (e.g., by the controller 40 and/or calculation processor 41) to reflect the characteristics in which a reaction rate increases depending on the temperature. For example, on the assumption that the amount of hydrogen peroxide produced is 1 time under basic reaction conditions, the temperature correction coefficient may be set so that the amount of hydrogen peroxide produced increases by 1.2 times whenever the internal temperature of the stack 20 increases by 10° C. The temperature correction coefficient may be set based on test data, and a change in the amount of hydrogen peroxide produced depending on a temperature increase may be reflected by the temperature correction coefficient.

A final amount of hydrogen peroxide produced may be determined/calculated (e.g., by the controller 40 and/or calculation processor 41) by multiplying the calculated amount of hydrogen peroxide produced under the basic conditions by the temperature correction factor. For example, if the amount of hydrogen peroxide produced under the basic conditions is 0.01 mg/hr and the internal temperature of the stack 20 rises from 20° C. to 30° C. and the temperature correction coefficient is set to 1.2, the final amount of hydrogen peroxide produced may be calculated as “Amount of hydrogen peroxide produced=0.01 mg/hr×1.2=0.012 mg/hr”.

Furthermore, the calculation processor 41 calculates the final accumulated amount of hydrogen peroxide by accumulating the amount of hydrogen peroxide produced based on temperature data measured for a certain period of time. For example, if the internal temperature of the stack 20 is maintained at 30° C. for a certain period of time, the accumulated amount of hydrogen peroxide after 10 hours may be calculated as “Accumulated amount of hydrogen peroxide produced=0.012 mg/hr×10 hours=0.12 mg” by accumulating the amount of hydrogen peroxide produced per hour (0.12 mg/hr).

As such, the calculation processor 41 may calculate the amount of hydrogen peroxide produced by reflecting the change in the internal temperature of the stack 20, and may calculate the accumulated amount of hydrogen peroxide produced using a characteristic in which, as a temperature rise continues, the amount of hydrogen peroxide produced increases proportionally (S100).

The accumulated amount of hydrogen peroxide produced per hour may be determined/calculated (e.g., by the controller 40 and/or calculation processor 41) based on the calculated accumulated amount of hydrogen peroxide produced. The amount of hydrogen peroxide produced accumulated for each hour may be determined/calculated (e.g., by the controller 40 and/or calculation processor 41), and the accumulated amount of hydrogen peroxide produced per hour may be determined/calculated (e.g., by the controller 40 and/or calculation processor 41) from an increase compared to the previous hour.

The calculated accumulated amount of hydrogen peroxide produced per hour may be transmitted (e.g., by the controller 40 and/or calculation processor 41) to the comparison processor 42.

The calculated accumulated amount of hydrogen peroxide produced per hour may be compared (e.g., by the controller 40 and/or comparison processor 42) with set values stored in the controller 40. For example, a determination may be made (e.g., by the controller 40 and/or the comparison processor 42) as to whether the accumulated amount of hydrogen peroxide produced per hour is greater than or equal to the first set value but is less than the second set value (S210).

If the accumulated amount of hydrogen peroxide produced per hour is greater than or equal to the first set value but is less than the second set value (S210—Yes), a signal indicating that the accumulated amount of hydrogen peroxide produced per hour is within a yellow zone may be transmitted/sent (e.g., by the controller 40 and/or the comparison processor 42) to the delay processor 43. The yellow zone refers to an area (e.g., in a graph/space of hydrogen peroxide accumulation over time) in which the slope of the accumulated amount of hydrogen peroxide per hour is greater than or equal to the first set value but is less than the second value.

If the signal indicating that the accumulated amount of hydrogen peroxide produced per hour is within the yellow zone is applied to/received by the delay processor 43, the delay processor 43 may initiate/start control to suppress production of hydrogen peroxide. The control may comprise initiating/entering the first step of the disconnection delay stage. In the first step of the disconnection delay stage, the delay processor 43 may strengthen the stop threshold of the fuel cell stack 20 and/or the restart threshold of the fuel cell stack 20, and reduce/limit an output increase rate during rapid acceleration so that the accumulated amount of hydrogen peroxide does not increase excessively. The stop threshold of the fuel cell stack 20 may be set as a first stop threshold, and the restart threshold of the fuel cell stack 20 may be set as a first restart threshold. A range between the first stop threshold and the first restart threshold may be set as a first set range, and the first set range may be a wider range than a default/normal range between a default/normal stop threshold and a default/normal restart threshold of the fuel cell stack 20 (e.g., set in advance in the controller 40). If the range between the fuel cell stop threshold and the fuel cell restart threshold of the fuel cell stack 20 is set as the first set range, and the frequency of stops of the fuel cell stack 20 may be reduced.

The stop threshold of the fuel cell stack 20 may be strengthened (e.g., by the controller 40 and/or delay processor 43) compared to before/outside of entering the disconnection delay stage, thereby reducing/preventing unnecessary stops and suppressing an increase in the accumulated amount of hydrogen peroxide. The first stop threshold means a condition in which demand output to stop the fuel cell stack 20 is lower than the demand output in the default stop threshold of the fuel cell stack 20 set in advance in the controller 40.

For example, the fuel cell stack 20 may be set by default to be stopped if the output of the fuel cell stack 20 was lowered to 20 kW or less. In the first step of the disconnection delay stage, the fuel cell stack 20 may be stopped in a lower output state, (e.g., if the output of the fuel cell stack 20 is lowered to 10 kW or less). This may prevent the fuel cell stack 20 from being unnecessarily stopped, and may reduce/

delay production of hydrogen peroxide.

The delay processor 43 may restart the fuel cell stack 20 only under a certain condition after stopping the fuel cell stack 20 by strengthening the restart threshold of the fuel cell stack 20 after stopping the fuel cell stack 20. In the first step of the disconnection delay stage, the controller 40 may set the restart threshold of the fuel cell stack 20 as the first restart threshold. The first restart threshold means a condition in which demand output to restart the fuel cell stack 20 is greater than the demand output in the default restart threshold of the fuel cell stack 20 set in advance in the controller 40.

More specifically, before the first step of the disconnection delay stage, the fuel cell stack 20 is allowed to be restarted if the output is recovered to 10 kW or more, but in the first step of the disconnection delay stage, the fuel cell stack 20 may be restarted only in a stabilized state by increasing the demand output to restart the fuel cell stack 20 to 15 kW or more. This may prevent the fuel cell system 10 from being overloaded due to frequent restart, and suppress an increase in the accumulated amount of hydrogen peroxide.

The delay processor 43 limits the output increase rate during rapid acceleration. Before entering the disconnection delay stage, the output of the fuel cell stack 20 may rapidly increase from 10 kW to 20 kW in a short period of time during rapid acceleration. However, after entering the first step, the delay processor 43 sets the output increase rate during rapid acceleration to increase by 5 kW in stages so as to suppress a rapid increase in the output (S220).

After completing the first step of the disconnection delay stage, the comparison processor 42 may determine again whether the accumulated amount of hydrogen peroxide per hour is greater than or equal to the second set value (S230). If the accumulated amount of hydrogen peroxide per hour is greater than or equal to the second set value and is thus within a red zone, the comparison processor 42 may transmit a signal indicating that the accumulated amount of hydrogen peroxide produced per hour is within the red zone to the delay processor 43. The red zone refers to an area in a plot/space of accumulated amount of hydrogen peroxide over time in which the slope of the accumulated amount of hydrogen peroxide per hour is greater than or equal to the second value.

If the signal indicating that the accumulated amount of hydrogen peroxide produced per hour is within the red zone is applied/received, the delay processor 43 may enter/initiate the second step of the disconnection delay stage and perform more stringent and reinforced control. In the second step of the disconnection delay stage (e.g., compared to the first step of the disconnection delay stage), the reinforced stop threshold and/or reinforced restart thresholds of the fuel cell stack 20 are applied and the increase rate of the output of the fuel cell stack may be more strictly limited during rapid acceleration, so that the production rate of hydrogen peroxide does not increase rapidly.

In the second step of the disconnection delay stage, the controller 40 may set the stop threshold of the fuel cell stack 20 as a second stop threshold, and/or sets the restart threshold of the fuel cell stack 20 as a second restart threshold. Furthermore, a range between the second stop threshold and the second restart threshold may be set as a second set range. The second set range may be a wider range than the first set range.

For example, the delay processor 43 may strengthen the stop threshold of the fuel cell stack 20 as the second stop threshold in the second step of the disconnection delay stage. In the first step of the disconnection delay stage, the shutdown system may be set to operate when/if the output of the fuel cell stack 20 is a first value (e.g. 10 kW) or less, but in the second step of the disconnection delay stage, this condition may be lowered to a second value lower than the first (e.g., 5 kW) or less so that the fuel cell stack 20 is stopped only at an even lower output.

The delay processor 43 may set the restart threshold of the fuel cell stack 20 in the second step of the disconnection delay stage as the second restart threshold. In the first step of the disconnection delay stage, the fuel cell stack 20 may be allowed to be restarted if the output is recovered to a first value (e.g., 15 kW) or more, but in the second step of the disconnection delay stage, the fuel cell stack 20 may be restarted only in a more stabilized state by adjusting the release condition to a second value higher than the first value (e.g., 20 kW) or more.

The delay processor 43 may more strictly limit the output increase rate during rapid acceleration in the second step of the disconnection delay stage (e.g., relative to in the first step or not in the disconnection delay stage). In the first step of the disconnection delay stage, the output may be set to increase by up to 5 kW during rapid acceleration, but in the second step of the disconnection delay stage, the output is set to increase by 2.5 kW in stages to suppress a rapid increase in the output (S240).

As such, the delay processor 43 performs the first step of the disconnection delay stage when/if the accumulated amount of hydrogen peroxide per hour is between the first set value and the second set value, and may performs the second step of the disconnection delay state when/if the accumulated amount of hydrogen peroxide per hour is greater than or equal to the second set value, thereby suppressing production of hydrogen peroxide in stages and preventing disconnection of the tube separator of the humidifier 30.

After performing the second step of the disconnection delay stage, the calculation processor 41 may calculate/determine the accumulated amount of hydrogen peroxide produced. The calculation processor 41 may determine/calculate the accumulated amount of the fuel oversupply excess (S300).

In an example of the present disclosure, the calculation processor 41 may calculate the fuel oversupply excess at a corresponding point in time by multiplying the accumulated amount of hydrogen peroxide produced by a proportional coefficient.

In another example of the present disclosure, the calculation processor 41 calculates a decrease in the membrane thickness of the humidifier 30, and the accumulated amount of the fuel oversupply excess based on the decrease.

For example, the accumulated amount of the fuel oversupply excess may be calculated using a proportional coefficient corresponding to the decrease in the membrane thickness of the humidifier 30, (e.g., based on the reduced membrane thickness of the humidifier 30).

Information on the calculated accumulated amount of the fuel oversupply excess may be transmitted to the comparison processor 42, and the comparison processor 42 may receive the information and determine whether the accumulated amount of the fuel oversupply excess exceeds the third set value (S400).

If the accumulated amount of the fuel oversupply excess exceeds the third set value, the comparison processor 42 may determine that the tube separator of the humidifier 30 is on the verge of disconnection, and generate a factory arrival and/or repair request notification so that a driver is capable of recognizing this state (S500). The notification may be transmitted to the driver through various routes, such as a vehicle display, a dashboard warning light, a mobile application, etc.

The present disclosure provides the method of preventing disconnection of the tube separator of the humidifier 30 in the fuel cell system 10. The method may comprise determining/calculating the accumulated amount of hydrogen peroxide produced and performing control (e.g., in stages) based on the calculated accumulated amount of hydrogen peroxide produced. The calculation processor 41 may determine/calculate the accumulated amount of hydrogen peroxide produced and transmit the calculated accumulated amount of hydrogen peroxide produced to the comparison processor 42. Thereafter, the comparison processor 42 may transmit a signal to the delay processor 43 so as to perform disconnection delay control through comparison the accumulated amount of hydrogen peroxide per hour with the set values stored in the controller 40. The delay processor 43 may control the stop threshold and/or restart threshold of the fuel cell stack 20 by selecting the first or second step of the disconnection delay stage based on the corresponding signal. If the accumulated amount of the fuel oversupply excess exceeds the third set value, the comparison processor 42 may provide a driver with a factory arrival and/or repair request notification so as to prevent damage to the tube separator of the humidifier 30.

The present disclosure has been made in an effort to solve the above-described problems associated with prior art, and it is an object of the present disclosure to provide a method of preventing disconnection of a humidifier tube in order to ensure stack durability of a fuel cell system.

It is another object of the present disclosure to provide a method of improving stability of a fuel cell system by diagnosing disconnection that may occur in a humidifier tube in real time and performing a control mode to delay the disconnection if necessary.

The objects of the present disclosure are not limited to the above-mentioned objects, and other objects not mentioned herein will be clearly understood by those skilled in the art from the following description and will be more clearly understood from examples of the present disclosure. The objects of the present disclosure may be realized by means and combinations thereof disclosed in the claims.

A humidifier disconnection prevention system for achieving the above-described objects of the present disclosure is configured as follows.

In one aspect, the present disclosure provides a humidifier disconnection prevention system including a fuel cell stack, a humidifier located adjacent to the fuel cell stack, an input unit configured to collect operating status information of the fuel cell stack, and a controller configured to calculate an accumulated amount of hydrogen peroxide produced by receiving the operating status information of the fuel cell stack from the input unit, wherein the controller controls a fuel cell stop threshold and a fuel cell restart threshold by determining whether an accumulated amount of hydrogen peroxide per hour is within a set range based on the calculated accumulated amount of hydrogen peroxide.

In an example, the controller may, by receiving the operating status information of the fuel cell stack from the input unit, calculates a stoichiometric ratio, calculate an accumulated amount of an air oversupply excess if the calculated stoichiometric ratio exceeds a reference value, and calculate an amount of hydrogen peroxide produced and the accumulated amount of hydrogen peroxide per hour from the accumulated amount of the air oversupply excess.

In another example, if the calculated accumulated amount of hydrogen peroxide per hour is greater than or equal to a first set value but is less than a second set value, the controller may correct the fuel cell stop threshold and the fuel cell restart threshold for the fuel cell stack output to define a first set range therebetween, and correct a fuel supply rate of the fuel cell stack to a first set rate.

In still another example, if the calculated accumulated amount of hydrogen peroxide per hour is greater than or equal to a second set value, the controller may correct the fuel cell stop threshold and the fuel cell restart threshold for the fuel cell stack output to define a second set range therebetween, and correct a fuel supply rate of the fuel cell stack to a second set rate.

In yet another example, the controller may, by receiving the operating status information of the fuel cell stack from the input unit, calculates an output value by substituting the received operating status information into a current-voltage characteristic curve, calculate an output reduction ratio by comparing the calculated output value with an initial available output value, and calculate an amount of hydrogen peroxide produced and the accumulated amount of hydrogen peroxide per hour from an accumulated amount of an air oversupply excess.

In another aspect, the present disclosure provides a method of diagnosing and preventing disconnection of a fuel cell humidifier including calculating, by a controller, an accumulated amount of hydrogen peroxide per hour, determining, by the controller, whether the accumulated amount of hydrogen peroxide per hour is within a set range and entering a disconnection delay stage corresponding to the set range if the accumulated amount of hydrogen peroxide per hour is within the set range, calculating, by the controller, an accumulated amount of an air oversupply excess from the accumulated amount of hydrogen peroxide per hour, and determining, by the controller, whether the accumulated amount of the air oversupply excess exceeds a set value.

In an example, the method may further include calculating, by the controller, a stoichiometric ratio by receiving a fuel amount and an air amount from an input unit, determining, by the controller, whether the calculated stoichiometric ratio exceeds a reference value, and calculating, by the controller, the accumulated amount of the air oversupply excess and the accumulated amount of hydrogen peroxide per hour from the calculated stoichiometric ratio exceeding the reference value.

In another example, the method may further include measuring, by an input unit, current and voltage, calculating, by the controller, an output value by substituting the measured current and voltage into a current-voltage characteristic curve, calculating, by the controller, an output reduction ratio by comparing the calculated output value with an initial available output value, and calculating the accumulated amount of hydrogen peroxide per hour from the accumulated amount of the air oversupply excess.

In still another example, the method may further include entering, by the controller, a first step of a disconnection delay stage if the accumulated amount of hydrogen peroxide per hour is greater than or equal to a first set value but is less than a second set value, and after entering, by the controller, the first step of the disconnection delay stage, entering, by the controller, a second step of the disconnection delay stage if the accumulated amount of hydrogen peroxide per hour is greater than or equal to the second set value.

In yet another example, the method may further include, if the accumulated amount of hydrogen peroxide per hour is greater than or equal to the first set value but is less than the second set value, setting a fuel cell stack stop threshold for a fuel cell stack output as a first stop threshold, setting a fuel cell stack restart threshold for the fuel cell stack output as a first restart threshold, and setting a fuel supply rate of the fuel cell stack as a first set rate.

In still yet another example, the method may further include, if the accumulated amount of hydrogen peroxide per hour is greater than or equal to the second set value, setting a fuel cell stack stop threshold for a fuel cell stack output as a second stop threshold, setting a fuel cell stack restart threshold for the fuel cell stack output as a second restart threshold, and setting a fuel supply rate of the fuel cell stack as a second set rate.

In a further example, the method may further include determining, by the controller, whether the accumulated amount of the air oversupply excess exceeds the set value, and calculating, by the controller, the accumulated amount of the air oversupply excess from a decrease in a membrane thickness of a humidifier tube of a vehicle in a disconnected state.

In still another aspect, the present disclosure provides a method of diagnosing and preventing disconnection of a fuel cell humidifier including calculating, by a processor, an accumulated amount of hydrogen peroxide per hour, determining, by the processor, whether the accumulated amount of hydrogen peroxide per hour is within a set range, and switching, by a delay processor, to a disconnection delay stage corresponding to the set range if the accumulated amount of hydrogen peroxide per hour is within the set range, calculating, by the processor, an accumulated amount of an air oversupply excess from the calculated accumulated amount of hydrogen peroxide per hour, and determining, by the processor, whether the accumulated amount of the air oversupply excess exceeds a set value.

In an example, the method may further include measuring, by an input unit, a fuel amount and an air amount supplied into a fuel cell stack, calculating, by the processor, a stoichiometric ratio by receiving the fuel amount and the air amount from the input unit, determining, by the processor, whether the calculated stoichiometric ratio exceeds a reference value, and calculating, by the processor, the accumulated amount of the air oversupply excess based on the calculated stoichiometric ratio exceeding the reference value, and calculating an amount of hydrogen peroxide produced and the accumulated amount of hydrogen peroxide per hour from the accumulated amount of the air oversupply excess.

In another example, the method may further include measuring, by an input unit, current and voltage at an output terminal of a fuel cell stack, receiving, by the processor, the measured current and voltage at the output terminal from the input unit, and calculating an output value by substituting the measured current and voltage into a current-voltage characteristic curve, and calculating, by the processor, an output reduction ratio by comparing the calculated output value with an initial available output value, calculating the accumulated amount of the air oversupply excess, and calculating an amount of hydrogen peroxide produced and the accumulated amount of hydrogen peroxide per hour based on the accumulated amount of the air oversupply excess.

As is apparent from the above description, the present disclosure may obtain the following effects through the configuration, combination and usage relations disclosed in the above-described examples.

First, the accumulated amount of hydrogen peroxide is monitored in real time and a control mode to delay disconnection is implemented if the accumulated amount of hydrogen peroxide per hour reaches a set range, thereby being capable of effectively preventing disconnection of a humidifier tube in a fuel cell stack. This increases the durability of a fuel cell system and enables the fuel cell system to be stably operated for a long time.

Second, excessive fuel oversupply is prevented by setting the control mode depending on the accumulated amount of hydrogen peroxide, thereby being capable of minimizing damage to the humidifier tube and reducing maintenance costs. This contributes to increasing the overall operating efficiency of the system.

Third, the internal state of the fuel cell stack may be stabilized, and unnecessary energy consumption may be reduced by controlling the accumulated amount of hydrogen peroxide, thereby providing the effect of improving fuel efficiency. This may further enhance the reliability of fuel cells.

The above detailed description is illustrative of the present disclosure. The above description is intended to illustrate the examples of the present disclosure, and the present disclosure may be used in various other combinations, modifications, and environments. That is, it should be apparent to those skilled in the art that various substitutions, changes and modifications which are not exemplified herein but are still within the spirit and scope of the present disclosure may be made. The described examples illustrate the best mode for implementing the technical idea of the present disclosure, and various changes required for specific application fields and uses of the present disclosure are also possible. Accordingly, the above detailed description of the disclosure is not intended to limit the present disclosure to the disclosed examples. Further, the appended claims should be construed to include other examples as well.

What is claimed is:

1. A humidifier system comprising:
a fuel cell stack;
a humidifier configured to control humidity in the fuel cell stack;
a sensor system comprising a plurality of sensors configured to measure operating status information of the fuel cell stack; and
a controller circuit configured to:
determine, based on the operating status information received from the sensor system, an accumulated amount of hydrogen peroxide produced by the fuel cell stack; and
control operation of the fuel cell stack according to a fuel cell stop threshold and a fuel cell restart threshold, wherein the fuel cell stop threshold and the fuel cell restart threshold are based on whether an accumulation rate of hydrogen peroxide is within a set range.

2. The humidifier system of claim 1, wherein the controller circuit is further configured to:
determine, based on the operating status information, that a stoichiometric ratio exceeds a predetermined reference value;
based on the stoichiometric ratio exceeding the predetermined reference value, determine an accumulated amount of an air oversupply excess; and
determine, based on the air oversupply excess, an amount of hydrogen peroxide produced and the accumulated rate of hydrogen peroxide.

3. The humidifier system of claim 2, wherein the controller circuit is further configured to:
based on the accumulation rate of hydrogen peroxide being greater than or equal to a first set value and less than a second set value:
set the fuel cell stop threshold to be a first fuel cell stop threshold;
set the fuel cell restart threshold to be a first fuel cell restart threshold, wherein the first fuel cell stop threshold and the first fuel cell restart threshold define a first set range therebetween; and
set a fuel supply rate of the fuel cell stack to a first set rate.

4. The humidifier system of claim 3, wherein the controller circuit is further configured to:
based on the accumulation rate of hydrogen peroxide being greater than or equal to the second set value:
set the fuel cell stop threshold to be a second fuel cell stop threshold; and
set the fuel cell restart threshold to be a second fuel cell restart threshold, wherein the second fuel cell stop threshold and the second fuel cell restart threshold define a second set range therebetween, and wherein the second set range is larger than the first set range; and
set a fuel supply rate of the fuel cell stack to a second set rate.

5. The humidifier system of claim 1, wherein the controller circuit is further configured to:
determine, based on the operating status information, an output value by substituting the received operating status information into a current-voltage characteristic curve;
determine an output reduction ratio based on a comparison between the determined output value and an initial available output value; and
determine, based on the output reduction ratio, an amount of hydrogen peroxide produced and the accumulation rate of hydrogen peroxide.

6. The humidifier system of claim 5, wherein the controller circuit is configured to:
based on the accumulated rate of hydrogen peroxide being greater than or equal to a first set value and less than a second set value:
set the fuel cell stop threshold to be a first fuel cell stop threshold;
set the fuel cell restart threshold to be a first fuel cell restart threshold, wherein the first fuel cell stop threshold and the first fuel cell restart threshold define a first set range therebetween; and
set a fuel supply rate of the fuel cell stack to a first set rate.

7. The humidifier system of claim 6, wherein the controller circuit is configured to:
based on the accumulation rate of hydrogen peroxide is being greater than or equal to the second set value:
set the fuel cell stop threshold to be a second fuel cell stop threshold; and
set the fuel cell restart threshold to be a second fuel cell restart threshold wherein the second fuel cell stop threshold and the second fuel cell restart threshold define a second set range therebetween, and
set a fuel supply rate of the fuel cell stack to a second set rate.

8. The humidifier system of claim 1, wherein the controller circuit is further configured to determine, based on an accumulation rate of hydrogen peroxide, an accumulated amount of an air oversupply excess; and
based on the accumulated amount of the air oversupply excess exceeding a set value, cause output, by a user interface, of a notification indicating a risk of humidifier disconnection.

9. A method performed by an apparatus of a humidifier system comprising:
receiving, by a controller circuit and from a sensor system, operating status information of a fuel cell stack;
determining, by the controller circuit based on the operating status information, an accumulation rate of hydrogen peroxide produced by the fuel cell stack;
determining, by the controller circuit, whether the accumulation rate of hydrogen peroxide is within one or more set ranges;
controlling an operation of the fuel cell stack according to a fuel cell stop threshold and a fuel cell restart threshold, wherein the fuel cell stop threshold and the fuel cell restart threshold are controlled based on whether the accumulation rate of hydrogen peroxide is within the set range.

10. The method of claim 9, further comprising:
determining, by the controller circuit and based on the accumulation rate of hydrogen peroxide, an accumulated amount of an air oversupply excess; and
based on the accumulated amount of the air oversupply excess exceeding a set value, causing output, by a user interface, of a notification indicating a risk of humidifier disconnection.

11. The method of claim 9, further comprising:
measuring, via the sensor system, an amount of fuel supplied to the fuel cell stack and an amount of air supplied to the fuel cell stack, wherein the operating status information comprises a measured amount of fuel and a measured amount of air;
determining, by the controller circuit, a stoichiometric ratio based on the measured amount of fuel and the measured amount of air;
determining, by the controller circuit, whether the stoichiometric ratio exceeds a reference value; and
determining, by the controller circuit based on the stoichiometric ratio exceeding the reference value, the accumulation rate of hydrogen peroxide.

12. The method of claim 9, wherein the operating status information comprises a current at an output terminal of the fuel cell stack and a voltage at the output terminal of the fuel cell stack, and wherein the method further comprises:
determining, based on the current and the voltage, an output value by substituting the current and the voltage into a current-voltage characteristic curve; and
determining, by the controller circuit, an output reduction ratio by comparing the output value with an initial available output value; and
determining the accumulation rate of hydrogen peroxide further based on the output reduction ratio.

13. The method of claim 9, wherein the determining, by the controller circuit, whether the accumulation rate of hydrogen peroxide per hour is within the set range comprises:
determining, by the controller circuit, that the accumulation rate of hydrogen peroxide is greater than or equal to a first set value but is less than a second set value, and
wherein the controlling the operation of the fuel cell stack according to the fuel cell stop threshold and the fuel cell restart threshold comprises controlling the operation of the fuel cell stack according to a first stop threshold and a first restart threshold that are set based on the accumulation rate of hydrogen peroxide being greater than or equal to the first set value and less than the second set value.

14. The method of claim 13, further comprising:
setting the fuel cell stop threshold to be the first stop threshold;
setting the fuel cell restart threshold to be the first restart threshold, wherein the first stop threshold and the first restart threshold define a first set range; and
setting a fuel supply rate of the fuel cell stack to a first set rate.

15. The method of claim 13, wherein the determining, by the controller circuit, whether the accumulation rate of hydrogen peroxide is within the set range further comprises:
determining, by the controller circuit, that the accumulation rate of hydrogen peroxide is greater than or equal to the second set value, and
wherein the controlling the operation of the fuel cell stack according to the fuel cell stop threshold and the fuel cell restart threshold comprises controlling the operation of the fuel cell stack according to a second stop threshold and a second restart threshold that are set based on the accumulation rate of hydrogen peroxide being greater than or equal to the second set value.

16. The method of claim 15, further comprises:
setting the fuel cell stop threshold to be the second stop threshold;
setting the fuel cell restart threshold to be the second restart threshold, wherein the second stop threshold and the second restart threshold define a second set range, wherein the second set range is larger than a first set range, and wherein the first stop threshold and the first restart threshold define the first set range; and
setting a fuel supply rate of the fuel cell stack as a second set rate.

17. The method of claim 9, further comprising:
determining, by the controller circuit, an accumulated amount of air oversupply excess from a decrease in a membrane thickness of a humidifier tube of a vehicle in a disconnected state.

18. A method performed by an apparatus of a humidifier system, the method comprising:
determining, by a controller circuit, an accumulation rate of hydrogen peroxide produced by a fuel cell stack;
controlling, by the controller circuit and based on the accumulation rate of hydrogen peroxide being within a set range, operation of the fuel cell stack according to one or more operation parameters corresponding to the set range;
determining, by the controller circuit, an accumulated amount of an air oversupply excess from the accumulation rate of hydrogen peroxide; and
causing, by the controller circuit and based on the accumulated amount of the air oversupply excess exceeding a set value, a user interface to output a notification indicating a risk of humidifier disconnection.

19. The method of claim 18, wherein the determining the accumulation rate of hydrogen peroxide comprises:
receiving, from a sensor system configured to measure an amount of fuel supplied to the fuel cell stack and an amount of air supplied to the fuel cell stack, a measured amount of fuel and a measured amount of air supplied into the fuel cell stack;
determining, by the controller circuit, a stoichiometric ratio based on the measured amount of fuel and the measured amount of air;
determining, by the controller circuit, whether the stoichiometric ratio exceeds a reference value; and
determining, by the controller circuit and based on the stoichiometric ratio exceeding the reference value, the accumulation rate of hydrogen peroxide.

20. The method of claim 18, wherein determining the accumulation rate of hydrogen peroxide comprises:
receiving, from a sensor system configured to measure a current at an output terminal of the fuel cell stack and a voltage at the output terminal, a measured current and a measured voltage at the output terminal;
determining an output value by substituting the measured current and the measured voltage into a current-voltage characteristic curve of the fuel cell stack;
determining, by the controller circuit, an output reduction ratio by comparing the output value with an initial available output value; and
determining, by the controller circuit and based on the output reduction ratio, the accumulation rate of hydrogen peroxide.
